(19) United States
(12) Patent Application Publication
(10) Pub. No.: US 2024/0284921 A1
(43) Pub. Date: Aug. 29, 2024

(54) PEELING MACHINE AND RELATIVE METHOD FOR PEELING STUFFED FOOD PRODUCTS

(71) Applicant: MAKER S.R.L., Berbenno di Valtellina (IT)

(72) Inventor: Marco PINALLI, Berbenno di Valtellina (IT)

(21) Appl. No.: 18/574,045

(22) PCT Filed: Jun. 11, 2022
(86) PCT No.: PCT/EP2022/065920

§ 371 Date: Dec. 25, 2023

(30) Foreign Application Priority Data
Jul. 19, 2021 (IT) 102021000019067

(51) Int. Cl. A22C 11/00

(52) U.S. Cl. CPC A22C 11/003

(57) ABSTRACT

Peeling machine (M) for peeling stuffed food products (K) into stuffing casings (B), comprising conveyor means (C) adapted to advance said sausages (K) in succession from an inlet (I) to an outlet (U) of said machine (M) in a direction (Z) of linear advancement and extending through a cutting station (T) for cutting casings (B) of said sausages (K), said cutting station (T) being defined by an engraving device (D, L) adapted to engrave longitudinally and superiorly the casing (B) of each said sausage (K); a unit (U1) for picking up said engraved casing (B), said picking unit (U1) being arranged immediately downstream of said cutting station (T) and defined by removal means adapted to at least partially remove said engraved casing (B).

The present invention relates to a peeling machine and relative method for peeling bagged or stuffed food products.

The invention in question is advantageously used in the food industry, in particular in the sector of peeling machines for sausages such as small salami, sausages, mortadellas or similar small, elongated and meat-based sausage products, to which the following description will explicitly refer without losing generality.

The purpose of the present invention is to create a peeling machine which is highly effective and rapid in the incision and subsequent elimination of the so-engraved stuffing casing.

Another object of the present invention is to provide a method for peeling sausages which is capable of effectively cutting the sausages by incision with subsequent rapid removal of the sausage casing thus cut.

A further object of the present invention is that of realizing a peeling machine which is quick and simple to maintain.

The structural and functional characteristics of the present invention and its advantages with respect to the known prior art will become even more clear and evident from the claims below, and in particular from an examination of the following description, made with reference to the attached figures which show a preferred but not limiting embodiment of the peeling machine in question, in which:

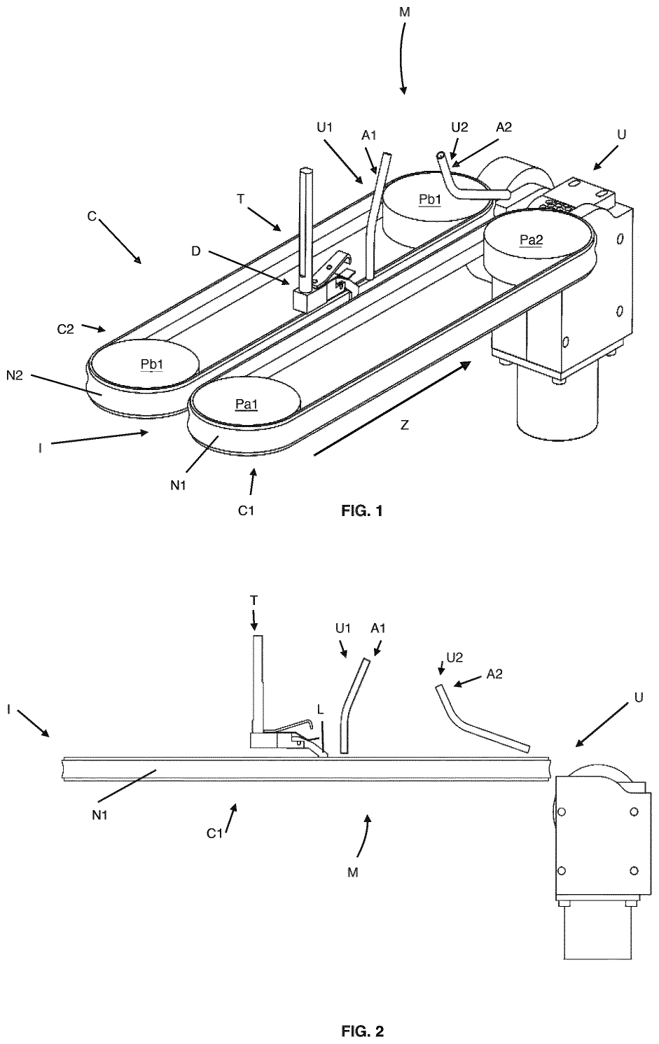

FIG. 1 is a schematic perspective view of an embodiment of the peeling machine object of the present invention;

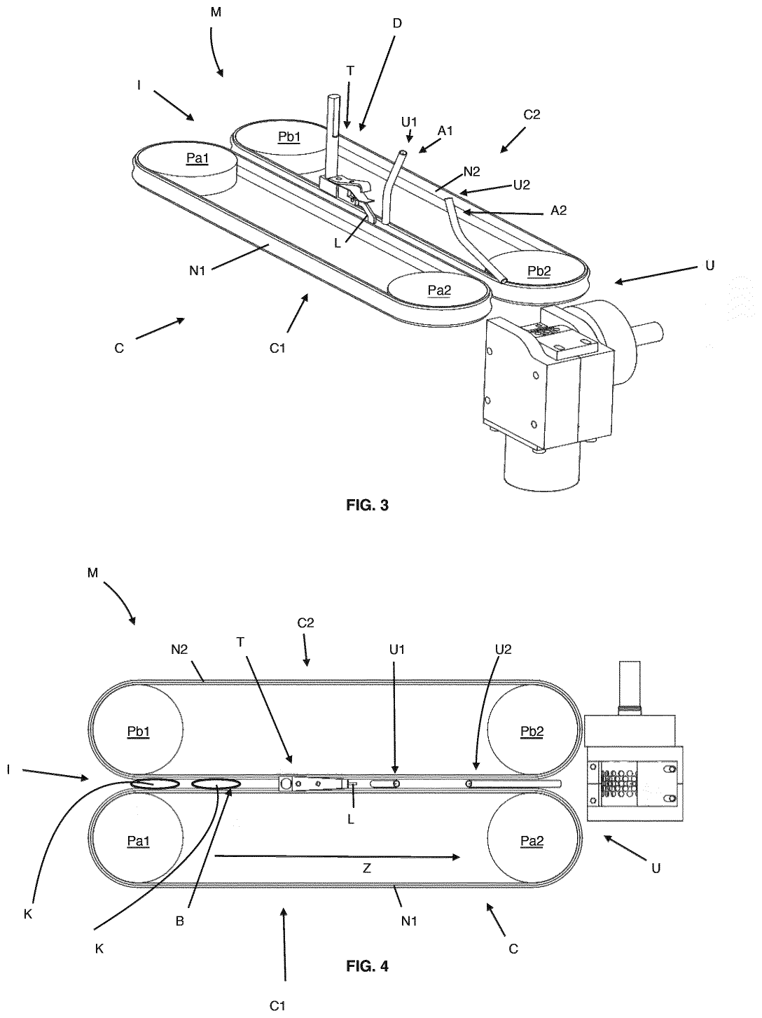

FIG. 2 is a schematic front view, with some parts removed for clarity, of the machine of FIG. 1;

FIG. 3 represents another schematic perspective view of the machine of FIG. 1;

FIG. 4 is a plan view of the peeling machine object of the present invention; And

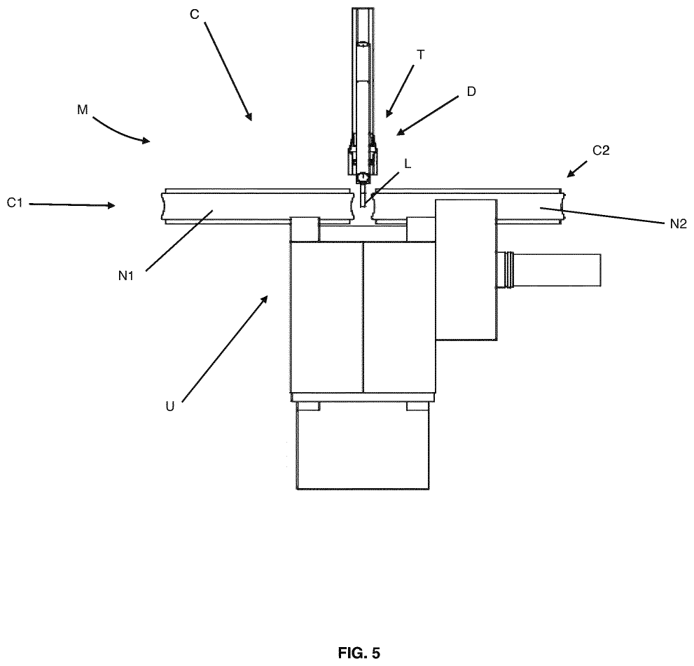

FIG. 5 is a side view of the peeling machine object of the present invention.

With reference to the attached FIGS. 1 to 5, M indicates globally and schematically a peeling machine for peeling sausages K (FIG. 4) such as salami, sausages, mortadellas or similar small, elongated sausage-based food products, such as meat.

The machine M comprises a support frame (not shown) for conveyor means C suitable for advancing, in succession, the sausages K from an inlet I of the machine M to an outlet U of the machine M itself and in a horizontal linear direction Z and extending through a station T for incising the sausages K themselves.

According to what is better illustrated in FIGS. 1, 3,4 and 5, the conveyor means C comprise two belt conveyors C1 and C2, arranged and acting on the opposite side with respect to the direction Z and each defined by a belt conveyor C1, C2 N1, N2 wound around two relative pulleys Pa1, Pa2 and Pb1, Pb2 rotating with vertical axes under the thrust of known and not illustrated motor means.

Station T is defined by an incision device D substantially comprising a blade L able to incise longitudinally and above the stuffing casing B of each sausage K.

Immediately downstream of the station T along the direction Z of advancement there is a unit U1 for withdrawing the engraved casing B of each sausage K, which unit U1 is defined by suction means A1 suitable for sucking the incised casing B at least up to partial removal of the casing B engraved so as to leave the casing B partially connected to the sausage K itself only to a rear end of the sausage K itself along the direction Z of advancement.

Finally, immediately upstream of the outlet U of the machine M, there is a unit U2 for definitive and final removal of the casing B still partially connected to the sausage K, which unit U2 is defined by suction means A2 adapted to definitively remove the casing B and in such a way leaving the sausage K leaving the machine M completely peeled and totally devoid of said casing B.

In this way, the machine M is perfectly and quickly capable of carrying out an effective peeling of the sausages K in accordance with the intended purposes.

1. Peeling machine for peeling stuffed food products into stuffing casings, comprising conveyor means adapted to advance said sausages in succession from an inlet to an outlet of said machine in a direction of linear advancement and extending through a cutting station for cutting casings of said sausages, said cutting station being defined by an engraving device adapted to engrave longitudinally and superiorly the casing of each said sausage; a unit for picking up said engraved casing, said picking unit being arranged immediately downstream of said cutting station and defined by removal means adapted to at least partially remove said engraved casing; wherein said conveyor means comprise two belt conveyors arranged and acting on opposite sides with respect to said direction of said sausages; each said two belt conveyors being defined by a belt conveyor wound around two relative pulleys rotating with vertical axes.

2. Machine according to claim 1, wherein further comprises a removal unit for definitive removing said casings still partially connected to said sausage, said removal unit being arranged immediately upstream of said outlet of said machine and defined by removal means able to completely eliminate said engraved casing from said sausage.

3. Machine according to claim 1, wherein said removal means comprise suction means.

4. Machine according to claim 1, wherein said removal means comprise blowing means.

5. Machine according to claim 1, wherein said cutting station is defined by an engraving device substantially comprising a blade suitable for engraving longitudinally and above the said casing for stuffing each said sausage.

6. Method for peeling stuffed food products into stuffing casings, wherein it comprises the following operational phases of: advancing the sausages in succession from an inlet to an outlet in a linear advancement direction; engrave the stuffing casing (B) of each said sausage, and at least partially remove said engraved casing from each said sausage.

7. Method according to claim 6, wherein it comprises the further step of removing said engraved casing for completely eliminate said engraved casing from said product.

8. Method according to claim 6, wherein said engraving step is carried out longitudinally and above said casing of each said sausage.
